(19) United States
(12) Patent Application Publication
(10) Pub. No.: US 2012/0271892 A1
(43) Pub. Date: Oct. 25, 2012

(54) METHOD AND APPARATUS FOR UTILIZING VISUALLY-ENCODED INFORMATION TO FACILITATE CONSUMER INFORMATION COLLECTION

(76) Inventor: Jeffrey W. Greenhouse, Hoboken, NJ (US)

(21) Appl. No.: 13/453,489

(22) Filed: Apr. 23, 2012

Related U.S. Application Data
(60) Provisional application No. 61/478,145, filed on Apr. 22, 2011.

(51) Int. Cl. G06F 15/16

(52) U.S. Cl. 709/206

(57) ABSTRACT

The present invention provides an engine, system and method for providing a method for capturing data, comprising executing a set of actionable instructions including an email address being visually encoded into a mark or symbol, executing the encoded instructions based on the voluntary actions of an individual on at least one system of hardware and software reading and decoding the mark, receiving at least one email message at the encoded address, and parsing of the email message to extract consumer-specific information.

### CROSS REFERENCE TO RELATED APPLICATION

This application claims priority to U.S. Provisional Patent Application Ser. No. 61/478,145, filed Apr. 22, 2012, the entirety of which application is incorporated herein by reference as if set forth in its entirety

### FIELD OF THE INVENTION

The present invention relates to collecting power from a remote device and, more particularly, to an system and method for providing power to a wireless tag.

### BACKGROUND OF THE INVENTION

They Businesses often desire to collect Information from consumers. One of the most common pieces of information collected from consumers is an email address. Current methods by which organizations collect information from consumers, include in web-based data entry forms and direct verbal interviews performed by employees or third-parties.

Numerous systems exist for visually encoding information into machine readable forms. These systems include one-dimensional barcodes, two-dimensional barcodes, OCR-friendly typefaces and digital watermarking.

Two-dimensional barcodes (also referred to as “C)R codes” or “Quick Response codes”) are frequently used to encode instructions intended for decoding by camera-enabled mobile phones. Camera-enabled devices decode the instructions and either execute them automatically, or offer the device user the option of executing the instructions. Similar instructions can be encoded using any other method of visual encoding, limited only by data capacity and reading/decoding technology. Presently, visually-encoded information is used to facilitate consumer data collection by encoding a URI, which guides the consumer to a web-based data entry form which they must then fill in and submit.

Currently, there are several methods by which the businesses can gather email addresses from consumers at a retail or business location. One method involves asking them to publicly state their email address, and manually taking it down in writing or on a computer. Problems with this method include: the business must implement a computerized collection system or a coordinated process of transcription (made more challenging for businesses with multiple locations); staff must be trained in the collection process; consumers may not feel comfortable publicly announcing their email address; only works when the business is open; and such actions slow down the regular operations of the business.

Additional methods may include asking customers to drop a business card into a container. However, problems with this method include. The business Must implement a process of transcription which may be very time-consuming (and complicated for businesses with multiple locations) and the fact that many consumers do not have business cards.

The business may also direct consumers to visit a website with a signup form, which the consumer must then fill in and submit. Problems with this method include: if the consumer attempts this method while at the business location, the consumer must have adequate mobile phone reception to reach the website hosting the signup form; the consumer must waft for the page to load, then type in their email address, press a submit button, then wait for the page submission to be processed; and it is relatively easy for the consumer to misspell one or more parts of their email address, resulting in a failed subscription.

Furthermore, consumers may have the option of participating in proprietary third-party loyalty programs, whereby the consumer must download a proprietary application and pre-register with a service that stores their information for later distribution to participating merchants may be similarly riddled with problems. Problems with this method may include: that the consumer must take extensive actions before being able to quickly subscribe at a participating merchant.

These existing solutions have requirements that make them inefficient and undesirable, including employee training, computer system upgrades, lack of privacy, and extensive navigating and typing by the consumer. This invention solves the problems with the current methods by providing a fast, efficient, private method for consumers to subscribe to a mailing list. It accomplishes this by visually encoding a set of routing information (unique to the individual mailing list and/or business location) into a format that can be read and decoded by modern smartphones. The decoded routing information automatically creates an email message, which also, contains the email address of the sender (the consumer). The invention then receives the generated email and parses it to assign and record the sender's email address to the proper list.

### SUMMARY

The invention disclosed herein makes the process of consumer data collection, including an email address, more efficient following a process that includes an instruction string created using the mail to URI scheme. The instruction string may be visually encoded using any of the available encoding methods known to those skilled in the artₛ and may be displayed or published. A consumer may use a camera-enabled device to capture and decode encoded information, which may generate an email to at least one address contained in the instruction string, which the consumer sends. At least one computer system receives the email and parses it, extracting the email address of the sender and, optionally, other information.

It is to be understood that both the foregoing general description and the following, detailed description are exemplary and explanatory, and are intended to provide further explanation of the invention as claimed.

### BRIEF DESCRIPTION OF THE DRAWINGS

The accompanying drawings are included to provide a further understanding of the disclosed embodiments. In the drawings:

FIG. 1 is a block diagram of an exemplary computing system for use in accordance with herein described systems and methods;

FIG. 2 is a block diagram showing an exemplary networked computing environment for use in accordance with herein described systems and Methods.

FIG. 3 is a block diagram showing devices operated by cooperating parties in an illustrative arrangement in accordance with herein described systems and methods.

FIG. 4 is an illustration of code compatible with the present invention.

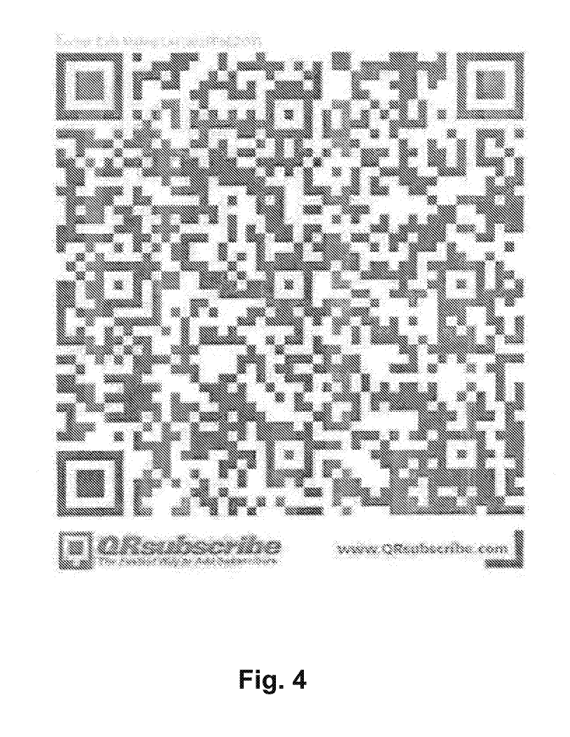

### DETAILED DESCRIPTION

The present invention allows businesses to easily gather email subscriptions for a mailing list from consumers with camera-enabled mobile phones. Businesses want to build their mailing lists, and the best time and place to do this is at the point of maximum engagement with the consumer. For retail establishments (restaurants, bars, shops, etc.), this point of maximum engagement is when the consumer is actually physically within their establishment. In this situation, the consumer is usually away from their personal computer, but usually has access to their mobile phone. Even at this pc:Mt of maximum engagement, the Consumer still has limited patience and limited willingness tog, through a long or complicated process.

QR codes have been used in some limited manner to encode SMS messages, which then facilitate subscription of a mobile phone number and a response message to the sending device.

There currently exist email list management systems that can add a subscriber as a result of that subscriber sending an email to a predetermined, published email address. This can occur as a result of the consumer manually typing in the destination email address, clicking on a mailto link embedded on a website, a marketing email or another digital product, or by replying to an email message they have received. For this method to be used in a mobile context, it requires the subscriber to either have digital access to the published email address or to manually type it in.

There are also systems that allow users to download provider specific applications, create a usage profile containing their information, then use those applications' to scan QR codes to send or associate their information with the owner of the code. This method does not operate the mail to protocol and requires the consumer to have downloaded a proprietary application and to have, either registered via an online portal or have previously entered their information into said application. As discussed below, the current art is devoid of using various' links embodied in the present invention to create and send an email.

Reference will now be made in detail to various exemplary and illustrative embodiments of the present invention.

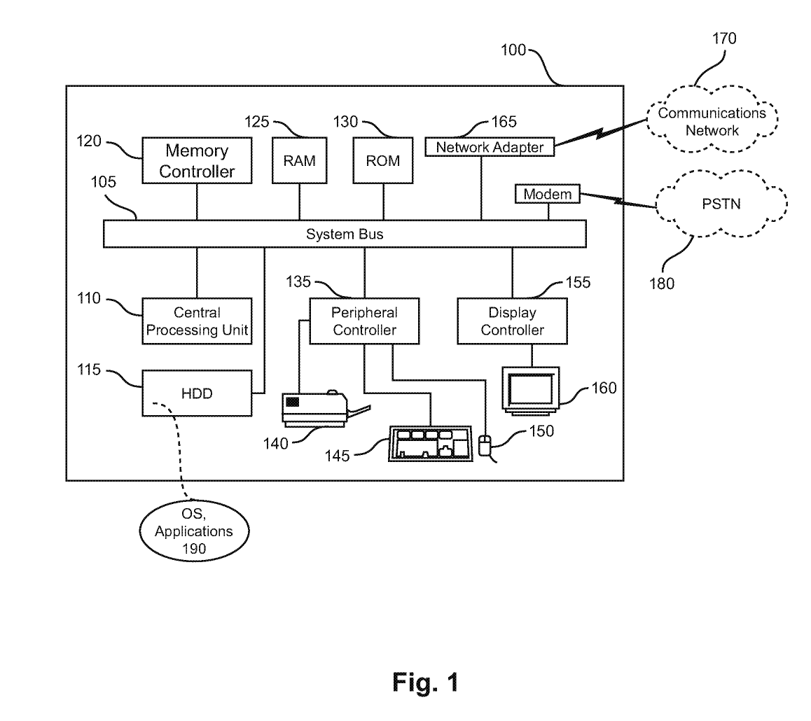

FIG. 1—depicts an exemplary computing system 10 that can be used in accordance with herein described system and methods. Computing system 100 is capable of executing software; such as: an operating system (OS) and a variety of computing applications 190. The operation of exemplary computing system 100 is controlled primarily by computer readable instructions, such—as instructions stored in a computer readable storage medium, such as hard disk drive (HDD) 115, optical disk (not shown) such-as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, and the like, CPU 110 is implemented in an integrated circuit called a processor.

It is appreciated that, although exemplary computing system 100 is shown to comprise a single CPU 110, such description is merely illustrative as computing system 100: may comprise a plurality of CPUs 110. Additionally, computing system 100 May exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as compute: instructions and other computer readable data, is transferred between components of computing system 100 via the system's main data-transfer path. The main data transfer path may use a system bus architecture 105, although other computer architectures (not shown) can be used, such as architectures using serializers and deserializers (serdes) and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory Within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output generated by computing system 100. Such visual output may include text, graphics, animated graphics, and/or video, for example. Display 160 may be implemented with a CRT-based video display, an LCD-based flat-panel display, gas plasma-based fiat-panel display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet. Communications network 170 may provide user access to computing system 100 with means of communicating and transferring software and information electronically. For example, users may communicate with computing system 100 using communication means such as email, direct data connection, virtual private network (VPN), Skype or other online video conferencing services, or the like. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

Computing system 100 may also contain modem 175 which may be used to couple computing system 100 to a telephone communication network, such as the public switched telephone network (PSTN) 180. PSTN E80 may provide user access to computing system 100 via so-called Plain Old Telephone Service (POTS), Integrated Services Digital Network (ISDN), mobile telephones, Voice over Internet Protocol (Vo1P), video telephones, and the like. It is appreciated that the modem connections shown are exemplary and other means of establishing communications links between computing system 100 and remote users may be used.

It is appreciated that exemplar/computing system 100 is merely illustrative of a computing environment in which the herein described: systems and methods may operate and does not limit the implementation of the herein described systems and methods in computing environments having differing components and configurations, as the inventive concepts described herein may be implemented in various computing environments using various components and configurations.

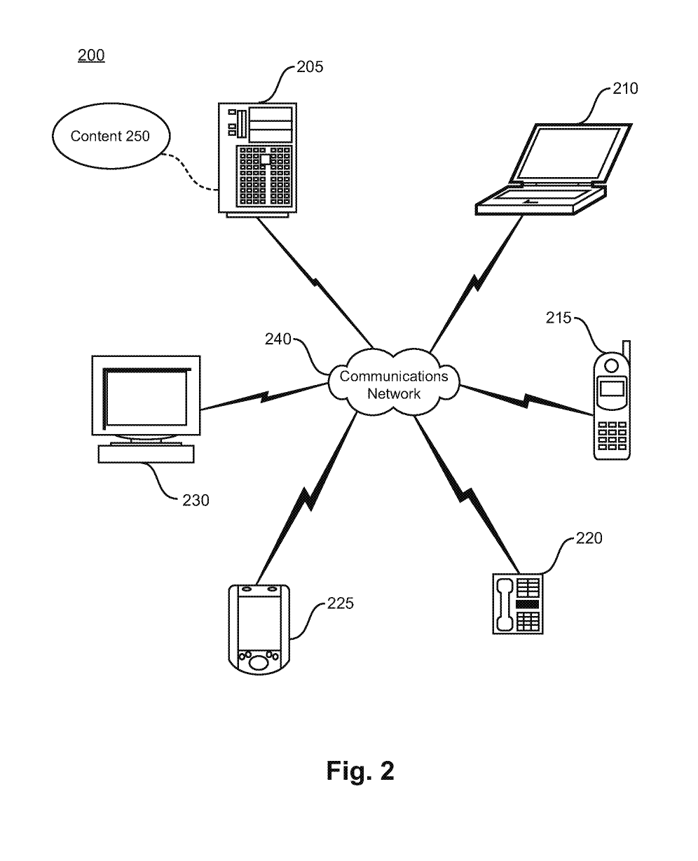

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, Intranet, extranet, peer-to-peer network, virtual private network, the Internet, or other communications network such as POTS, ISDN, VoIP, PSTN, etc,) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (H I FP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or the like, to interact with server 205.

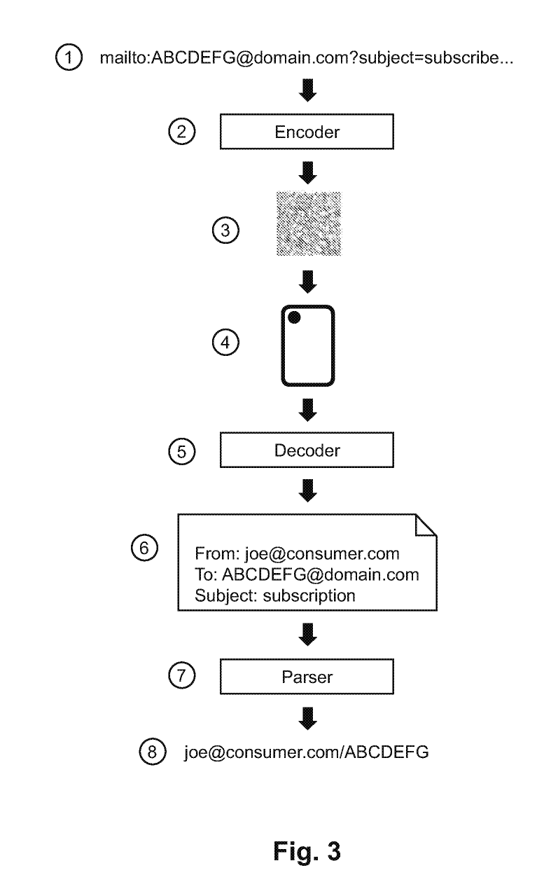

As illustrated in FIG. 3, an instruction string may be created using the mailto URI scheme. This instruction string may contain an email address and may contain a subject line, a message body and/or other parameters that the format supports. The instruction String may be fed into an encoder, which may create a machine-readable visual representation of the instruction string in the case of the sample code provided in Listing A (below), this visual representation may be in the form of a 2-dimensional QR code. As contemplated herein, the visual representation may be in any format that may be reliably decoded by available technology without data loss. This could include traditional one-dimensional barcodes, color patterns, various 2-dimensional bar code formats, or even machine-readable typefaces. The resulting visual representation may be posted, displayed or otherwise made available to consumers and may use digital and/or analog encoding schemes.

The visual representation may be scanned by a consumer device, via a camera or scanner, such as those built into mobile phones. A decoder may process the captured image data and extract the original instruction string from step 1, which may allow for a transition between digital and/or analog encoding, for example. The extracted instruction string may then be executed by the consumer device, creating at least one email message containing the routing information and, by virtue of the email standard itself, the consumer's email address.

The email generated in step 6 may be received by a parser, which may analyze the message headers and extract routing information and the consumer's email address (and potentially additional consumer information or processing instructions). Routing could be guided by data included in the destination (“to:”) email address, Cc, Bcc, Subject or message body. The extracted data may then be stored and used to prompt additional actions.

The visual codes (containing routing Information) created by this invention may be posted on a store counter, in a shop window, placed on a restaurant menu, printed on shopping bags, or published in virtually any other type of marketing or advertising materials. The process of the present invention may make the subscription process much faster for the consumer, may not require any public disclosure of private email information, and may require no involvement from the merchant's staff. Additionally, the extraction of email addresses from email headers significantly reduces the potential for typographical errors in the captured information.

Listing A: Sample Code:

Visual Encoding of Routing Information—The following code compiles the mailto link with the routing email address and encodes it into a 2-dimensional barcode (a QR code):

<cffunction access=″private″ narrie-⁻.″$RencierCoden output=.″yes″
returntypeeboolean″>

<cfargument name=″id″ type⁻-⁻-″numeric″ requiredr-″yes″ hint=″The id of the

code to be rendered.″>

<cfset qrcode moderdroode″),finciOne(wherweidOlargumentsidttⁱ AND

accountID = #session.loggedInUser.id#″)>

```
  <off not IsStruct(qrcode)>
  <cfreturn false>
  <cfelse>
```

<cfscript>

greodeTo grcode.code;
Subject ″Subscribe″;
Body-7 ″Please subscribe me to the #ctreode;displayName#

list.#chr(10)##chr(10)#PoWered by http://ORSubscribe.com″;

URLtext t--

mailto:kirCodeTo#@drsubscribe,com?Subject=#URLencodedForrnat(Subje
ct)ti&Bodr#UriEncodedFormat(body)/1″;

</cfscript>
<I-- initialize writer and create a new barcode matrix --->
<cfset BarcodeForrnat

createObject(lava′,¹congoogieszxing.BarcodeForman>

<cfset writer

createObject(′java¹com.g000le,zxing,droode.CIRCodeVV.riter),Init( )>

<cfset bitMatrix tz Writer.encode( URLtext, BarcodeFormat,QR_CODE, 514, 514)>
<I-- render the matrix as a bufferedimage --->
<cfset converter

```
  createObject(′java‘,‘corn.google.ixing.dienLj2se.MatrixTolmageWriter′)> <cfset buff =
  converter.toBufferedimage( bitMatrix ) I>
```

<I— convert it to a CF compatible image
<cfset imgCode = ImageNew( buff ) I>
<cfset iniageFooter

ImageReed(Vapplication,wheels.appdirectory#/#appilootion,wheels.imagepat
h#/codeFooter_514.png″)>

<cfset irngFinal =ImageNw(′T″, 514, 560, ′r b″, ″white″)>
<cfirnage actiOn=″write″ source=″#imgCode#″ for at.″jpg″

destination=″#application,wheels.appdirectory#/#application.wheels.imagepat
htt/grbuffer/code_#qrcode.code#_plain.jpg″ overwriteteyesu>

<cfset textAttribUtes StructNewO>
<cfset textAttributes.font ″ArialUnicodeMS″>
<cfset textAttributes.sie ″11″>
<cfset IrnageSetAntiallasing(imgCode, ″n) 1>
<cfset ImageSetDrawingColor(imgCode, ″888888°)>
<cfset ImageDrawText(ImgCode, ″Itdrcode.displayNarne#

(#circode,codet-t)″, 36, 30, teXtAttributes)>

<cfset ImagePaste(irngFinal, imgCode, 0, 0)> <cfset
imagePaste(irngFinal, ImageFooter, 0, 490)>
<cfirnage action = ″write″ source=″#irngFinal#″ format=″jpg″

destination=″#application.whees.appdirectorygittapplication.wheels.imagepat
hAtiorbuffer/cede ilorc,ode.code4jp ″ overwrite=″yes″>

<cfreturn true>

<fcflf>

</cffunction>

Parsing and Matching—The following code retrieves an all sent to the routing address and parses it to identify and store subscriber information:

<cffunction name=″processrnair>
<cfpop action = ″getheaderonly″ name = ″GetHeaders″ maxrows=″20″
server = ″#application.wheels.retrievalEmailServer#” username =

“#application.wheelssetrievalEmailAddress#” password =
“#application.wheels.retrievalEmailPassword#”>

<cfset progress = QueryNew(″from_emall, from_name, to_code,

p_result″)>

<cfif GetHeaders.recordCount GREATER THAN 0>
<cfloop query=″GetHeaders″>
<cftry>

<cfscript>

if(ListLen(from, ″< >″) eq 1)
{

from_email = from;
from_name ″ ″;

} else {

startDelim FindNoCase(“<″, from);
endDelim FindnoCase(″>″, from, startDelim);
from email mid(from, startDelim + 1, endDelim

startDellrn − 1);

from_name = trim(RemoveChars(from, startDelim,

endDelim − startDelim + 1));

```
  }
  if(FindNoCase(″<″, to))
  {
```

startDelim FindNoCase(″<″, to);
endDelim FindNoCase(″>″, to, startDelim);
to email mid(to, startDelim + 1, endDelim

startDelim − 1);

}else {

to_email = to;

}
to_code = ListFirst(to_emall, ″@″);

</cfscript>

<cfstoredproc procedure=″sp_saveSubscriptonFromCode″

datasource=″#application.wheels.datasourcename#″
username=″#application.wheels.datassourceusername#″
password=”#application.wheels.datasourcepassword#”>

<cfprocparam type=″In″ cfsqltype=″CF_SQL_VARCHAR″

value=”#from_emai#” maxlength=″50″ nul=″no″>

<cfprocparam type=″in″ cfsqltype=″CF_SQL_VARCHAR″

value=”#to_code#″ maxlength=″25″ null=″no″>

<cfprocparam type=″In″ cfsqltype=″CF_SQL_VARCHAR″

value=″#from_name#″ maxlength=″200″ null=″no″>

<cfprocparam type=″Out″ cfsqltype=″CF_SQL_VARCHAR″

variable=”p_result″ maxlength=″50″ null-″no″>

<cfprocresult narne=″foundCode”>

</cfstoredproc>
<cfcatc type=”Object″>

<cfset p_result=′Error′>

</dfcatch>

</cftry>
<cfset newRow=QueryAddRow(progress)>
<cfset QuerySetCell(progress, ″from_email”,_{:}from_email, newRow)>
<cfset QuerySetCell(progress, ″frorn_name″, from_name, newRow)>
<cfset QuerySetCell(progress, ″to_code″, to_code., newRow)>
<cfset QuerySetCell(progress, “p_result”, p_result, newRow)>
<cffile action = “append″

file=″#applicationmheels.appdirectory#/logs/emailLogsi/email#dateFormat(no w( ),
″yyyymnidd″)#.log″ output=”#dateFormat(now( ), ″yyyy-mm-dd″)#
#timeFormat(now( ),
″HH:mm:ss″)##chr(9)##p_result##chr(9)##from##chr(9)##to#chr(9)##subject#″>

<cfif foundCode.recordCount EQ 1 AND foundCode.allowAutoReply AND

foundCode.autoReply>

<cfset sendEmail(

from=””″#foundCode.autoReplyFrom#″<system ©crsubscribe.com>″,

rep!yto⁼foundCode.autoReplyFrom,
to=from_email,
template=”/autornator/email_autoreply″,
subject=foundCode.autoReplySubject,
body=foundCode.autoReplyBody
)>

<icflf>
</cfloop>

<cfpop server = “#application.wheels.retrievalErnailServer#

```
    username =”#application.wheels.retrievalEmailAddress#″ password =
    ″#application,wheels.retrievalEmaiiPassword#″ action =″delete″
    uid=⁻#valueList(Getileaders.uid)#″>
```

</cfif>

</cffunction>

Those of skill in the art will appreciate that the herein described systems and methods are susceptible to various modifications and alternative constructions. There is no intention to limit the scope c)f the appended claims to the specific constructions described herein. Rather, the herein described systems and methods are intended to cover all modifications, alternative constructions, and equivalents falling within the scope and spirit of the appended claims and their equivalents.

What is claimed is:

1. A method for capturing data, comprising
executing a-set of actionable Instructions including an email address being visually encoded into a mark or symbol;
executing the encoded instructions based on the voluntary actions of an individual on at least one system of hardware and Software reading and decoding said mark;
receiving at least one email message at the encoded address; and
parsing of the email message to extract consumer-specific information.

2. The method of claim 1, further including the extraction and storage of the senders email address.

3. The method of claim 1, further including the generation and transmission of an email message in response to the message that has been received and parsed.
